(19) United States
(12) Patent Application Publication
(10) Pub. No.: US 2022/0202052 A1
(43) Pub. Date: Jun. 30, 2022

(54) AROMATIC ALKAMIDES AND METHODS OF USE THEREOF IN TASTE MODULATION

(71) Applicant: INTERNATIONAL FLAVORS & FRAGRANCES INC., Union Beach, NJ (US)

(72) Inventors: Ajay Pratap SINGH, Union Beach, NJ (US); Hassan Mustaq UBAIDEEN, Union Beach, NJ (US); Jung-A KIM, Union Beach, NJ (US); Michelle Eve HUBER, Union Beach, NJ (US); Thumpalasseril V JOHN, Union Beach, NJ (US)

(73) Assignee: INTERNATIONAL FLAVORS & FRAGRANCES INC., Union Beach, NJ (US)

(21) Appl. No.: 17/604,021

(22) PCT Filed: Apr. 17, 2020
(86) PCT No.: PCT/US2020/028644

§ 371 Date: Oct. 15, 2021

Related U.S. Application Data
(60) Provisional application No. 62/835,057, filed on Apr. 17, 2019.

(51) Int. Cl. A23L 27/00; A23L 27/10

(52) U.S. Cl. CPC A23L 27/84; A23V 2002/00; A23L 27/11; A23L 27/86

(57) ABSTRACT

A Lepidium meyenii extract, as well as aromatic alkamides thereof are described for use in compositions and methods for improving the taste of a consumable containing a component having an astringent, bitter or off-taste.

This application is a 371 of international application serial number PCT/US2020/028644 filed Apr. 17, 2020 and claims the benefit of priority of U.S. provisional patent application Ser. No. 62/835,057 filed Apr. 17, 2019, the contents of which are incorporated herein by reference in their entirety.

### BACKGROUND

There has been increasing concern about high levels of consumption of both fat and sugar, and a corresponding concern about lower levels of protein consumption. The food industry has addressed those concerns by providing a variety of products enriched with proteins isolated from plants. However, plant protein materials available in the market have an undesirable astringent and strong off-taste due to isoflavones associated therewith. Removal of isoflavones in the production of protein concentrates and plant protein isolates is one approach. However, isoflavones have a number of health benefits and their removal increases processing costs. As an alternative, more sugar or fat has been added to cover bitterness and adjust flavor perception. Flavorists simply “over flavor” their products to hide the offending taste. This approach is wholly unsatisfactory, especially for health-conscious consumers where reduced fat and sugar content is a common goal. Therefore, other approaches for masking the astringent and strong off-taste of plant protein materials have been sought.

US 2002/0193342 A1 describes the addition of sucralose to a product to mask the unpleasant taste of an amino acid component other than arginine. Similarly, WO 2017/037181 A1 teaches the use of one or more off-note blocking compounds including fatty acids, carbonyls, sweet brown, esters, sweeteners, lactones and juice derivatives to block, mask or modify the undesirable off-note of a non-animal derived protein. Bertelsen, et al. ((2018) J. Sci. Food Agric. 98 (10):3860-9) describe xylitol, sucrose, α-cyclodextrin, and maltodextrin as bitter-masking agents of an enzyme-treated soy protein in an aqueous model and in a bread model. GB 201304301 D0 teaches the addition of octadecalactone to a consumable product base to reduce off tastes such as the bitterness of whey protein or high-intensity sweeteners. U.S. Pat. No. 9,668,505 B2 describes edible films and gummi confectioneries including, e.g., fruit flavors, GSB Natural Masking Agent, hydrogenated and ethoxylated glycerol esters, and nucleotides that mask the taste of bitter tasting foods and/or foods that contain proteins. Further, EP 2058297 A1 describes the use of alkamides for masking the astringent taste of an unpleasantly tasting substance.

Lepidium meyenii, commonly called maca or Peruvian ginseng, is a perennial plant having a fleshy, edible, tuberous root. Traditionally, maca root is consumed for food and is also consumed for its medicinal properties including, e.g., enhanced fertility and treatment of chronic fatigue. In this respect, extracts of L. meyenii have been described for use in enhancing consumable products such as alcoholic beverages (EP 1743934 B1), coffee-flavored buccal tablets (CN 103478523 B), wine (CN 105368669 B, CN 105199927 B), compound syrups (CN 104256821 B), beverages to alleviate physical fatigue (CN 103918965 B, CN 102960810 B), and health food products (JP 4627477 B2, JP 2007222116 A). In addition, compositions containing extracts of L. meyenii root or macamides thereof have been suggested for use in the treatment of cancer and sexual dysfunction (U.S. Pat. No. 6,267,995 B1, US RE43005 E1, U.S. Pat. No. 7,985,434 B2, US 2018/0110818 A1, US 20180110817 A1). Furthermore, macamide B isolated from L. meyenii has been suggested for use in as a sweet taste modulator in a composition including at least one sweetener (US 20180132516 A).

### SUMMARY OF THE INVENTION

This invention provides a consumable including a component having an astringent, bitter or off-taste; and one or a combination of aromatic alkamides selected from the group of N-benzyloleamide, N-benzyl linoleamide, N-benzyllinolenamide, macamide 2, macamide 1, N-(3-Methoxybenzyl) oleamide, N-benzyloctadecanamide or (9Z,12Z)-N-[(3-methoxyphenyl)methyl]-9,12-octadecadienamide, e.g., at a concentration in the range of 1 part per trillion to 1000 parts per million in the consumable. The invention also provides a method for improving the taste of a consumable by adding to a consumable having a component with an astringent, bitter or off-taste, one or a combination of aromatic alkamides in an amount effective to reduce or suppress said astringent, bitter or off-taste. A component having an astringent, bitter or off-taste can include a protein, carbohydrate sweetener, artificial sweetener or preservative. In some aspects, the aromatic alkamides are in the form of an aromatic alkamide-enriched Lepidium meyenii extract, e.g., an ethanolic, ethyl acetate or isobutanol extract of L. meyenii root. In a further aspect, the consumable is a food product, pharmaceutical composition, a dietary supplement, a nutraceutical, a dental hygienic composition, a tabletop sweetener, a beverage, or a cosmetic product.

### DETAILED DESCRIPTION OF THE INVENTION

It has now been found that an extract of Lepidium meyenii, as well as aromatic alkamides isolated from the same, effectively mask the bitter, astringent and off-tastes of consumable products. In particular, it has been shown that saturated and unsaturated macamides of a L. meyenii extract reduce or suppress bitter, astringent and off-tastes associated with proteins. Accordingly, the present invention provides consumables and methods, which include one or more aromatic alkamides as isolated compounds or in the form of an L. meyenii extract, as additives to improve the taste of the consumable by reducing or suppressing the astringency, bitterness and/or off-taste of the consumable.

Lepidium meyenii Walpers (Brassicaceae) commonly known as Maca is an annual herbaceous edible plant native to the high plateaus of the Peruvian central Andes. L. meyenii is grown for its fleshy hypocotyl that is fused with a taproot, which is typically dried to a powder or flour and used as a root vegetable or in traditional medicine. Maca is primarily composed of 60-75% carbohydrates, 10-14% protein, 8.5% dietary fiber, and 2.2% fats. Maca is rich in calcium and potassium, and contains the essential trace elements iron, iodine, copper, manganese, and zinc, as well as fatty acids including linolenic acid, palmitic acid, and oleic acids. Maca also contains polysaccharides, glucosinates such as glucotropaeolin and m-methoxyglucotropaeolin, polyphenols, (1R,3S)-1-methyl-1,2,3,4-tetrahydro-β-carboline-3-carboxylic acid, p-methoxybenzyl isothiocyanate and more than 19 aromatic alkamides known as “macamides” (Wu et al. (2013) Bioorg. Med. Chem. 21:5188-5197).

As used herein, a L. meyenii extract is an extract from the roots or aerial part of L. meyenii. In certain embodiments, the L. meyenii extract is an extract from the root or hypocotyl of the plant. Preferably, the L. meyenii extract is enriched for one or more aromatic alkamides, also more specifically referred to herein as “macamides.” In some embodiments, the L. meyenii extract is enriched for one or more aromatic alkamides having the general structure of Formula I:

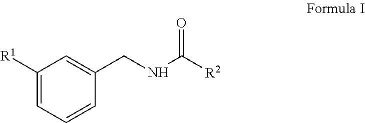

wherein R¹ is a hydrogen or methoxy (—O—CH₃) group and R² is a substituted or unsubstituted C₁₃₋₂₃ alkyl or alkenyl group.

As used herein, an “alkyl” group refers to a hydrocarbon group, which may be a straight or linear chain and may optionally be substituted. The alkyl group may have 13 to 23 carbon atoms, i.e., C₁₃-C₂₃, wherein the numerical range “13 to 23” refers to each integer in the given range, e.g., “13 to 23 carbon atoms” means that the alkyl group may have 13 carbon atoms, 15 carbon atoms, 17 carbon atoms, etc., up to and including 19 carbon atoms. By way of example, “C₁₅-C₁₇ alkyl” indicates that there are 15 to 17 carbon atoms in the alkyl chain. Alkyl groups of use in a compound of Formula I include tridecanyl, tetradecanyl, pentadecanyl, hexadecanyl, heptadecanyl, octadecanyl, and nonadecanyl groups.

An “alkenyl” group of this invention refers to a linear hydrocarbon group of 13 to 23 carbon atoms, i.e., C₁₃-C₂₃, containing one to four double bonds, which may optionally be substituted. Alkenyl groups of use in a compound of Formula I include tridecenyl, tetradecenyl, pentadecenyl, hexadecenyl, heptadecenyl, octadecenyl, and nonadecenyl groups with one, two, three or four double bonds.

Examples of substituents of the alkyl and alkenyl groups independently include, e.g., nitro, hydroxy or oxo, C₁₋₃ alkyl, or C₁₋₃ alkoxy (e.g., methoxy, ethoxy, propoxy, isopropoxy), In certain embodiments, the number of the substituents is 1 to 3, e.g., 1, 2 or 3.

In certain embodiments, the L. meyenii extract is enriched for one or more of the following aromatic alkamides: (i) N-Benzyloleamide; (ii) N-Benzyllinoleamide; (iii) N-Benzyllinolenamide; (iv) Macamide 2; (v) Macamide 1; (vi) N-(3-Methoxybenzyl) oleamide; (vii) N-Benzyl octadecanamide; and (viii) (9Z,12Z)-N-[(3-methoxyphenyl)methyl]-9,12-octadecadienamide (Table 1), and may include other aromatic/aliphatic alkamides such as N-benzyl-(9,16)-dioxo-(10E,12E,14E)-octadecatrieneamide, N-benzyl-(16)-hydroxy-(9)-oxo-(10E,12E,14E)-octadecatrieneamide, N-benzyl-(9)-oxo-(12Z,15Z)-octadecadienamide, N-benzyl-(13)-oxo-(9E,11E)-octadecadienamide, N-benzyl-(9)-oxo-(12Z)-octadecenamide, N-benzyl octanamide, N-benzyl-(15Z)-tetracosenamide.

TABLE 1

| Aromatic Alkamide | Structure |
|---|---|
| (CAS No.) | (synonyms) |
| N-Benzyloleamide (101762-87-2) | 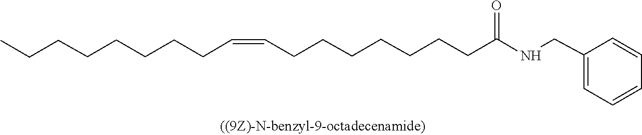 [SMILES: CCCCCCCC/C=C\CCCCCCCC(=O)NCc1ccccc1] |
| N- Benzyllinoleamide (18286-71-0) | 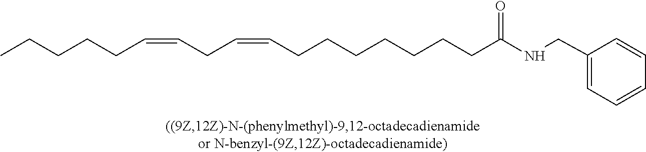 [SMILES: CCCCC/C=C\C/C=C\CCCCCCCC(=O)NCc1ccccc1] |
| N- Benzyllinolenamide (883715-18-2) | 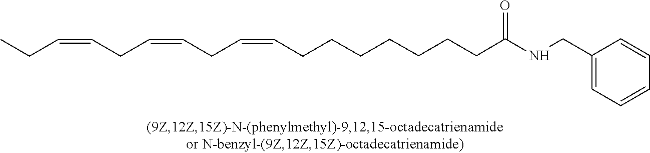 [SMILES: CC/C=C\C/C=C\C/C=C\CCCCCCCC(=O)NCc1ccccc1] |
| Macamide 2 (405906-95-8) | 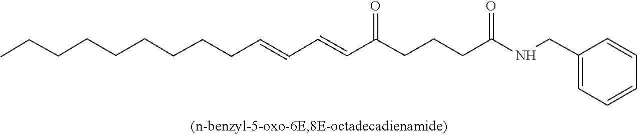 [SMILES: CCCCCCCCC/C=C/C=C/C(=O)CCCC(=O)NCc1ccccc1] |
| Macamide 1 (74058-71-2) | 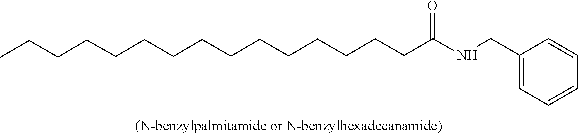 [SMILES: CCCCCCCCCCCCCCCC(=O)NCc1ccccc1] |
| N-(3- Methoxybenzyl) oleamide (883715-21-7) | 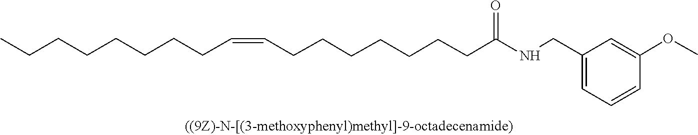 [SMILES: CCCCCCCC/C=C\CCCCCCCC(=O)NCc1cccc(OC)c1] |
| N-Benzyl octadecanamide (5327-45-7) | 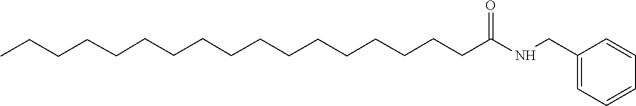 [SMILES: CCCCCCCCCCCCCCCCCC(=O)NCc1ccccc1] |
| (9Z,12Z)-N-[(3- methoxyphenyl) methyl]-9,12- octadecadienamide (883715-22-8) | 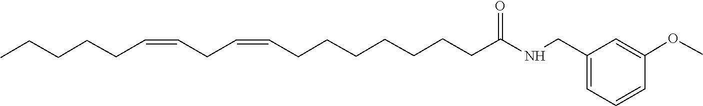 [SMILES: CCCCC/C=C\C/C=C\CCCCCCCC(=O)NCc1cccc(OC)c1] |

Total aromatic alkamides in dried plant material has been found in the of range from 0.0016% to 0.013% (w/w) (Li, et al. (2017) J. Food Quality Article ID:2904951; McCollom, et al. (2005) Phytochem. Anal. 16 (6):463-469). A L. meyenii extract is enriched for one or more aromatic alkamides, when said aromatic alkamides constitute between 0.1% and 100% (w/w) of the extract, or more preferably between 10% and 100% (w/w) of the extract, or most preferably between 50% and 100% (w/w) of the extract.

A L. meyenii extract can be obtained by grinding, milling or pulverizing dried L. meyenii plant material (e.g., dried L. meyenii root) to obtain a powder and subsequently suspending the powder in a solvent for a time sufficient to extract the desired aromatic alkamides from the plant material (e.g., 30 minutes to 24 hours) and filtering the extract to remove insoluble plant material (De Gruyter, et al. (2017) Z. Naturforsch. 72 (11-12)c:449-57; Valentova, et al. (2006) Cell Biol. Toxicol. 22 (2):91-9; D'Arrigo, et al. (2004) Revista Peruana de Biología. 11:103-106; Zhang, et al. (2006) J. Ethnopharmacol. 105 (1-2):274-9). Solvents of use in obtaining a L. meyenii extract include polar or semi-polar organic solvents such as water, 2-butanol, 1-butanol, isobutanol, ethanol, isopropyl alcohol, acetone, ethyl acetate, hexane, cyclohexane, or a combination thereof. In certain embodiments, a L. meyenii extract is obtained using a mixture of water and ethanol, e.g., 80%, 85%, 90% or 95% ethanol. Extraction can be carried out at a temperature in the range of 25° C. to 70° C., or more preferably at approximately 50° C. Ideally, a jacketed reactor with constant stirring or any other extraction equipment with constant percolation is used in the preparation of a L. meyenii extract. In other embodiments, a L. meyenii extract is concentrated under vacuum and subjected to additional liquid-liquid extraction by diluting the concentrated extract (e.g., a concentrated ethanolic extract) with water and extracting with one or more water immiscible solvents, e.g., 2-butanol, 1-butanol, isobutanol, ethyl acetate, or a mixture of ethyl acetate and 2-butanol, 1-butanol, or isobutanol to improve the taste activity. Preferably, liquid-liquid extraction is carried out with a mixture of 10% to 90% ethyl acetate and 90% to 10% 2-butanol, 1-butanol, or isobutanol.

Alternatively, an extract containing aromatic alkamides can be obtained using supercritical carbon dioxide (Cho, et al. (2013) Food Sci. Biotechnol. 22 (3):859-64) or ultrasound-assisted extraction (UAE) using petroleum ether as the solvent (Chen, et al. (2017) Molecules 22 (12):2196).

Aromatic alkamides of use in this invention can be used in the form of an enriched L. meyenii extract or as isolated compounds. In some embodiments, the aromatic alkamides are isolated from a L. meyenii extract by chromatographic fractionation based on molecular sizing, charge, solubility and/or polarity. Depending on the type of chromatographic method, column chromatography can be carried out with matrix materials composed of, for example, dextran, agarose, polyacrylamide or silica and can include solvents such as dimethyl sulfoxide, pyridine, water, dimethylformamide, methanol, saline, ethylene dichloride, chloroform, propanol, ethanol, isobutanol, formamide, methylene dichloride, butanol, acetonitrile, isopropanol, tetrahydrofuran, dioxane, chloroform/dichloromethane, etc. Typically, the product of the chromatographic step is collected in multiple fractions, which may then be tested for the presence of the desired compound using any suitable analytical technique (e.g., thin layer chromatography, mass spectrometry). In certain embodiments, a L. meyenii extract is fractionated using flash chromatography to prepare potent taste active fractions containing aromatic alkamides. In particular embodiments, taste active aromatic alkamides from a L. meyenii extract are sub-fractionated on a reverse phase (C-18) high performance liquid chromatography (HPLC) column attached to flash chromatography. In accordance with this embodiment, the L. meyenii extract may be dissolved in ethanol and transferred to a C-18 column and conditioned with water and ethanol (60:40 v/v). Flash chromatography may be carried out at a flow rate of 10 ml/min and effluents monitored using variable UV absorbance. Sub-fractions may be subsequently dried using vacuum evaporator or freeze drying. Fractions enriched in one or more of the desired aromatic alkamides may then be selected for further purification. In certain embodiments, an isolated aromatic alkamide is at least 50%, 60%, 70%, 80%, 90%, 95%, or 99% pure.

Alternatively, isolated aromatic alkamides of this invention may be obtained from a commercial source (e.g., Synnovator, Inc., Cary, N.C.) or chemically synthesized. For example, aromatic amides may be prepared as derivatives of oleic, linoleic and linolenic acids and benzylamine or 3-methoxybenzylamine (Wu, et al. (2013) Bioorgan. Med. Chem. 21 (17):5188-97). See also CN 104513171 A.

The L. meyenii extract (including fractions thereof) and isolated aromatic alkamides described herein improve the taste and/or flavor of a consumable by masking the astringency, bitterness and/or off-taste of a consumable, which has a component that imparts said astringent, bitter and/or off-taste. In this respect, a consumable includes any food product, pharmaceutical composition, dietary supplement, nutraceutical, dental hygienic composition, tabletop sweetener, beverage, or cosmetic product that includes a component having an astringent, bitter, and/or off-flavor. Preferably, the consumable having a component with an astringent, bitter or off-taste is modified by adding (a) a L. meyenii extract; (b) a L. meyenii root extract; (c) one or more isolated aromatic alkamides obtained from a L. meyenii extract; (d) one or more isolated aromatic alkamides obtained from a L. meyenii root extract; (e) a combination of a L. meyenii root extract and one or more isolated aromatic alkamides obtained from a L. meyenii extract; (f) N-benzyloleamide, N-benzyl-linoleamide, N-benzyllinolenamide, Macamide 2, Macamide 1, N-(3-methoxybenzyl)oleamide, N-benzyloctadecanamide, (9Z,12Z)-N-[(3-Methoxyphenyl)methyl]-9,12-octadecadienamide, or a combination thereof, or (f) a L. meyenii root extract in combination with one or more of N-benzyloleamide, N-benzyl-linoleamide, N-benzyllinolenamide, Macamide 2, Macamide 1, N-(3-methoxybenzyl)oleamide, N-benzyloctadecanamide, or (9Z,12Z)-N-[(3-Methoxyphenyl)methyl]-9,12-octadecadienamide.

In particular embodiments, the consumable having a component with an astringent, bitter or off-taste is modified by adding (a) N-benzyloleamide; (b) N-benzyloctadecanamide; (c) Macamide 1; (d) Macamide 2; (e) a combination of N-benzyloleamide and Macamide 1; (f) a combination of N-benzyloleamide and Macamide 2; (g) a combination of N-benzyloleamide and N-benzyloctadecanamide; or (h) a combination of N-benzyloleamide, N-benzyloctadecanamide, Macamide 1, and Macamide 2.

The term “mask” or “masking” as used herein, is defined as covering, disguising, and/or obscuring an astringent, bitter, and/or off-flavor by the addition of a L. meyenii extract and/or aromatic alkamide(s), wherein the component associated with the astringent, bitter, and/or off-flavor remains unchanged, but its unpleasant taste is not perceived by a human consuming said consumable.

The taste and/or flavor profile of a consumable including the L. meyenii extract and/or aromatic alkamide(s) of the invention may be improved or enhanced (e.g., by 1.5-, 2.0-, 2.5-, 5.0-, 7.5- or 10-fold improvement) compared to the taste and/or flavor profile of a comparative consumable which does not include the L. meyenii extract and/or aromatic alkamide(s) as exogenous additives. Ideally, the L. meyenii extract and/or aromatic alkamide(s) reduces the off-flavor taste by at least about 10%, 20%, 30%, 40%, 50%, 60%, 70%, 80%, 90%, or 95%, or from about 60% to about 99%, or alternatively from about 20% to about 50% compared to the consumable not including the L. meyenii extract and/or aromatic alkamide(s).

In certain embodiments, the L. meyenii extract and/or aromatic alkamide(s) of the invention reduce, suppress or mask the astringency, bitterness, and/or off-flavor of a consumable. An “off-flavor” or “off-taste” refers to a bitter, sour, fishy, earthy, gritty, pasty, burnt, beany, astringent, chalkiness, metallic and/or unpleasant taste of a consumable. “Astringent” or “astringency” refers to a puckering or mouth drying sensation felt in the oral cavity. “Bitter” or “bitterness” refers to one of the four basic tastes, perceived primarily at the back of the tongue, which is often described as sharp, pungent, or disagreeable.

The component having an astringent, bitter and/or off-taste can be a protein, carbohydrate sweetener, artificial sweetener or preservative that is inherently present in the consumable (e.g., in food products containing fruits) or said component is added to the consumable. In certain embodiments, the component having an astringent, bitter and/or off-taste is a protein. A protein with an astringent, bitter, and/or off-flavor can include an amino acid, protein hydrolysate or protein component of a consumable, in particular a plant protein or milk of grass-eating animals. Sweeteners of the present invention include, but are not limited to, carbohydrate sweeteners such as sucrose, fructose, glucose, high fructose corn syrup (containing fructose and glucose), xylose, arabinose, rhamnose, and sugar alcohols, such as erythritol, xylitol, mannitol, sorbitol, or inositol. Artificial sweeteners include, but are not limited to, Natural Sweet Flavor #2 (WO 2012/129451), stevioside, rebaudioside A, rebaudioside B, rebaudioside C, rebaudioside D, rebaudioside E, rebaudioside F, dulcoside A, dulcoside B, stevia, alpha-glucosyl stevia, fructosyl stevia, galactosyl stevia, beta-glucosyl stevia, siamenoside, mogroside IV, mogroside V, Luo Han Guo sweetener, monatin and its salts, glycyrrhizic acid and its salts (e.g., as found in MAGNASWEET), curculin, thaumatin, monellin, mabinlin, brazzein, hernandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, cyclocarioside I, or a combination thereof. Examples of preservatives having an astringent, bitter and/or off-taste include, but are not limited to benzoic acid and sorbic acid.

When added to a consumable as an exogenous additive, a L. meyenii extract and/or aromatic alkamide(s) of the invention is used in an amount effective to reduce or suppress the astringent, bitter or off-taste of a component of the consumable having an astringent, bitter or off-taste. Ideally, the amount of L. meyenii extract and/or aromatic alkamide(s) included in the consumable does not impart any off-taste to the consumable. Preferably, the amount of L. meyenii extract and/or aromatic alkamide(s) present in the consumable is an amount as low as 1 ppt, in an amount as low as 50 ppt, in an amount as low as 100 ppt, in an amount as low as 1 ppb, in an amount as low as 10 ppb or in an amount as low as 100 ppb. The L. meyenii extract and/or aromatic alkamide(s) can be included in the consumable in an amount that is as high as 1000 ppm, in an amount as high as 500 ppm, or in an amount as high as 100 ppm. The L. meyenii extract and/or aromatic alkamide(s) may further be present within any range delimited by any pair of the foregoing values, such as between 1 ppt and 100 ppm, between 10 ppt and 1 ppm, between 50 ppt and 50 ppm for example. The terms “ppt,” “ppb,” and “ppm” as used herein respectively mean part per trillion, part per billion and part per million by weight or volume.

L. meyenii extract and/or aromatic alkamides of this invention have been associated with a number of activities including, e.g., antidepressant activity, antioxidant activity, energizing properties, sexual dysfunction activity, estrogenic properties, hepatoprotective activity, immunostimulant effects, osteoporosis effects, etc. As a commercial supplement having serving sizes in the range of 500-2000 mg, the recommended use of L. meyenii (Maca root or root extract) is a serving 1-2 times per day. In clinal trial studies, administration of 500-3500 gram/day maca root was found to be well-tolerated (Dording, et al. (2008) CNS Neurosci Ther. 14 (3):182-191; Zenico, et al. (2009) Andrologia 41 (2):95-99; Brooks, et al. (2008) Menopause. 15 (6):1157-1162; Gonzales, et al. (2002) Andrologia 34 (6):367-72; Stone, et al. (2009) J. Ethnopharmacol. 126 (3):574-6). Given that the L. meyenii extract and/or aromatic alkamides are used in amounts significantly lower than those suggested for achieving a therapeutic benefit, the instant compositions are distinct from the pharmaceuticals, dietary supplements and nutraceuticals described in the prior art. As such, the compositions of this invention may provide taste modulating activity without associated pharmacological activity.

The phrase “food product” as used herein includes, but is not limited to, fruits, vegetables, juices, meat products (e.g., ham, bacon and sausage), egg products, fruit concentrates, gelatins and gelatin-like products (e.g., jams, jellies, preserves, and the like) milk products (e.g., ice cream, sour cream and sherbet), icings, syrups including molasses, corn products, wheat products, rye products, soybean products, oat products, rice products and barley products, nut meats and nut products, cakes, cookies, confectionaries (e.g., candies, gums, fruit flavored drops, and chocolates), chewing gum, mints, creams, ice cream, pies and breads, and beverages such as coffee, tea, carbonated soft drinks (e.g., those sold under the trademarks COKE® and PEPSI®), non-carbonated soft drinks, juices and other fruit drinks, sports drinks such those sold under the trademark GATORADE®, alcoholic beverages, such as beers, wines and liquors. Food products also include condiments such as herbs, spices and seasonings, and flavor enhancers, such as monosodium glutamate. A food product also includes prepared packaged products, such as dietetic sweeteners, liquid sweeteners, granulated flavor mixes which upon reconstitution with water provide non-carbonated drinks, instant pudding mixes, instant coffee and tea, coffee whiteners, malted milk mixes, pet foods, livestock feed, tobacco, and materials for baking applications, such as powdered baking mixes for the preparation of breads, cookies, cakes, pancakes, donuts and the like. Food products also include diet or low-calorie food and beverages containing little or no sucrose. Especially preferred food products are carbonated beverages.

The consumable can also be a pharmaceutical composition. Preferred compositions are pharmaceutical compositions containing the L. meyenii extract and/or aromatic alkamides and one or more pharmaceutically acceptable excipients. These pharmaceutical compositions can be used to formulate pharmaceutical drugs containing one or more active agents that exert a biological effect other than taste modulation. The pharmaceutical composition preferably further includes one or more active agents that exert a biological or pharmacological effect. Such active agents include pharmaceutical and biological agents that have an activity other than taste modulation. Such active agents are well known in the art. See, e.g., The Physician's Desk Reference. Such compositions can be prepared according to procedures known in the art, for example, as described in Remington's Pharmaceutical Sciences, Mack Publishing Co., Easton, Pa. In one embodiment, such an active agent includes bronchodilators, anorexiants, antihistamines, nutritional supplements, laxatives, analgesics, anesthetics, antacids, H₂-receptor antagonists, anticholinergics, antidiarrheals, demulcents, antitussives, antinauseants, antimicrobials, antibacterials, antifungals, antivirals, expectorants, anti-inflammatory agents, antipyretics, and mixtures thereof. In one embodiment, the active agent is a antipyretic or analgesic, e.g., ibuprofen, acetaminophen, or aspirin; laxative, e.g., phenolphthalein dioctyl sodium sulfosuccinate; appetite depressant, e.g., amphetamine, phenylpropanolamine, phenylpropanolamine hydrochloride, or caffeine; antacidic, e.g., calcium carbonate; antiasthmatic, e.g., theophylline; antidiuretic, e.g., diphenoxylate hydrochloride; agent active against flatulence, e.g., simethecon; migraine agent, e.g., ergotaminetartrate; psychopharmacological agent, e.g., haloperidol; spasmolytic or sedative, e.g., phenobarbitol; antihyperkinetic, e.g., methyldopa or methylphenidate; tranquilizer, e.g., a benzodiazepine, hydroxinmeprobramate or phenothiazine; antihistaminic, e.g., astemizol, chloropheniramine maleate, pyridamine maleate, doxlamine succinate, bromopheniramine maleate, phenyltoloxamine citrate, chlorocyclizine hydrochloride, pheniramine maleate, or phenindamine tartrate; decongestant, e.g., phenylpropanolamine hydrochloride, phenylephrine hydrochloride, pseudoephedrine hydrochloride, pseudoephedrine sulfate, phenylpropanolamine bitartrate, or ephedrine; beta-receptor blocker, e.g., propanolol; agent for alcohol withdrawal, e.g., disulfuram; antitussive, e.g., benzocaine, dextromethorphan, dextromethorphan hydrobromide, noscapine, carbetapentane citrate, or chlophedianol hydrochloride; fluorine supplement, e.g., sodium fluoride; local antibiotic, e.g., tetracycline or cleocine; corticosteroid supplement, e.g., prednisone or prednisolone; agent against goiter formation, e.g., colchicine or allopurinol; antiepileptic, e.g., phenyloine sodium; agent against dehydration, e.g., electrolyte supplement; antiseptic, e.g., cetylpyridinium chloride; NSAID, e.g., acetaminophen, ibuprofen, naproxen, or salt thereof; gastrointestinal active agent, e.g., loperamide and famotidine; an alkaloid, e.g., codeine phosphate, codeine sulfate, or morphine; supplement for a trace element, e.g., sodium chloride, zinc chloride, calcium carbonate, magnesium oxide, or other alkali metal salt or alkali earth metal salt; vitamin; ion-exchange resin, e.g., cholestyramine; cholesterol-depressant or lipid-lowering substance; antiarrhythmic, e.g., N-acetylprocainamide; or expectorant, e.g., guaifenesin.

In some embodiments, the consumable is a dietary supplement or nutraceutical. Examples of such compositions having an undesirable taste include, but are not limited to, enteral nutrition products for treatment of nutritional deficit, trauma, surgery, Crohn's disease, renal disease, hypertension, obesity and the like, to promote athletic performance, muscle enhancement or general well-being or inborn errors of metabolism such as phenylketonuria. In particular, such compositions can contain one or more amino acids which have a bitter or metallic taste or aftertaste. Such amino acids include, but are not limited to, essential amino acids such as L isomers of leucine, isoleucine, histidine, lysine, methionine, phenylalanine, threonine, tryptophan, tyrosine, and valine.

In a further embodiment, the consumable of the present invention is a dental hygienic composition, containing a L. meyenii extract and/or aromatic alkamide(s) of this invention. Dental hygienic compositions are known in the art and include, but are not necessarily limited to, toothpaste, mouthwash, plaque rinse, dental floss, dental pain relievers (such as a pain reliever sold under the trademark ANBESOL™), and the like. In one embodiment, the dental hygienic composition includes one sweetener. In another embodiment, the dental hygienic composition includes more than one sweetener. In certain embodiments, the dental hygienic composition includes sucrose and corn syrup, or sucrose and aspartame.

In yet another embodiment, the consumable of the present invention is a cosmetic product containing a L. meyenii extract and/or aromatic alkamide(s) of this invention. For example, but not by way of limitation, the cosmetic product can be a face cream, lipstick, lip gloss, and the like. Other suitable compositions of the invention include lip balm, such as those sold under the trademarks CHAPSTICK® or BURT'S BEESWAX® Lip Balm.

The invention is described in greater detail by the following non-limiting examples.

### Example 1: Ethanolic Extract of L. meyenii

One hundred grams of dried and milled L. meyenii root (80 mesh size) was loaded in a jacketed chemglass vessel percolator. To the dried material was added 500 mL of 95% ethanolic solution (95% food grade ethanol containing 5% water, v/v). The resulting mixture was percolated for 3 hours at 50° C. to 52° C. and the extract was discharged and collected in a separate vessel. The above extraction procedure was repeated one more time with 500 ml of 95% ethanolic solution under identical conditions. Both extracts were pooled together, filtered and concentrated to a dry paste with a 15% yield (w/w).

### Example 2: Ethyl Acetate Extract of L. meyenii

One hundred grams of dried and milled L. meyenii root (80 mesh size) was loaded in a jacketed chemglass vessel percolator. To the dried material was added 500 mL of an ethyl acetate solution. The resulting mixture was percolated for 3 hours at 50° C. to 52° C. and the extract was discharged and collected in a separate vessel. The above extraction procedure was repeated one more time with 500 ml of ethyl acetate solution under identical conditions. Both extracts were pooled together, filtered and concentrated to a dry paste with a 1% yield (w/w).

### Example 3: Isobutanol Extract of L. meyenii

One hundred grams of dried and milled L. meyenii root (80 mesh size) was loaded in a jacketed chemglass vessel percolator. To the dried material was added 500 mL of an isobutanol solution. The resulting mixture was percolated for 3 hours at 50° C. to 52° C. and the extract was discharged and collected in a separate vessel. The above extraction procedure was repeated one more time with 500 ml of an isobutanol solution under identical conditions. Both extracts were pooled together, filtered and concentrated to a dry paste with a 1.8% yield (w/w).

### Example 4: Analysis of L. meyenii Extracts

Based on LC-MS analysis (Table 2), the ethanolic extract of L. meyenii included several aromatic alkamides along with fatty acids, alkaloids and other minor compounds.

TABLE 2

| | | |
|---|---|---|
| | Molecular | |
| Name | Weight | RT [min] |

Major components tentatively identified in positive mode

| | | |
|---|---|---|
| Arginine | 174.11 | 1.35 |
| Proline | 115.06 | 1.59 |
| Choline | 103.10 | 1.63 |
| 1,3-Dibenzyl-4,5-dimethylimidazole | 276.16 | 5.64 |
| 1,3-Dibenzyl-2,4,5-trimethylimidazole | 290.18 | 5.75 |
| 1,3-Dibenzyl-2,4,5- | 320.19 | 5.86 |
| trimethylimidazole related | | |
| Fatty acid | 294.22 | 8.46 |
| N-Benzyl-9-oxo-12Z,15Z- | 383.28 | 8.91 |
| octadecadienamide or isomer | | |
| Linolenic acid | 278.22 | 8.93 |
| N-Benzyl-9-oxo-12Z,15Z- | 383.28 | 9.07 |
| octadecadienamide or isomer | | |
| N-Benzyl-9-oxo-12Z-octadecenamide | 385.30 | 9.15 |
| N-(3-methoxybenzyl)-(9Z,12Z,15Z)- | 397.30 | 9.51 |
| octadecatrienamide | | |
| (9Z,12Z,15Z)-N-(Phenylmethyl)- | 367.29 | 9.51 |
| 9,12,15-octadecatrienamide* | | |
| (9Z,12Z)-N-[(3- | 399.31 | 9.73 |
| Methoxyphenyl)methyl]-9,12- | | |
| octadecadienamide* | | |
| (9Z,12Z)-N-(Phenylmethyl)-9,12- | 369.30 | 9.74 |
| octadecadienamide* | | |
| N-(m-Methoxybenzyl) hexadecanamide | 375.31 | 9.94 |
| Macamide 1 (N-benzylhexadecanamide)* | 345.30 | 9.96 |
| (9Z)-N-[(3-Methoxyphenyl)methyl]-9- | 401.33 | 10.01 |
| octadecenamide* | | |
| 9-Octadecenamide, N-(phenylmethyl)-, | 371.32 | 10.03 |
| N-Benzyloctadecanamide* | 373.33 | 10.36 |

Major components tentatively identified in negative mode

| | | |
|---|---|---|
| Disaccharide | 342.12 | 1.60 |
| Methylmalonic acid | 118.03 | 2.75 |
| 4-Oxoproline | 129.04 | 2.82 |
| Benzylglucosinolate | 409.04 | 3.81 |
| N-Acetylvaline | 159.09 | 3.91 |
| Methoxybenzylglucosinolate | 439.05 | 4.08 |
| Azelaic acid | 188.10 | 5.33 |
| Corchorifatty acid F | 328.22 | 6.00 |
| Trihydroxy-15-octadecenoic acid | 330.24 | 6.18 |
| Fatty acid | 308.20 | 6.96 |
| Fatty acid | 312.23 | 7.15 |
| Fatty acid | 294.22 | 7.85 |
| Fatty acid | 294.22 | 8.45 |

Accordingly, the L. meyenii root extract of this invention is a rich source of protein, amino acids, minerals, alkaloids, and phenolics.

For each of the examples prepared in Examples 1, 2, and 3, the total amount of known macamides was determined. The results of these analyses are presented in Table 3.

TABLE 3

| | | Ethyl | |
|---|---|---|---|
| | Ethanol | Acetate | Isobutanol |
| | Extract | Extract | Extract |
| Constituent | (Example 1) | (Example 2) | (Example 3) |
| N-benzyl-9-oxo- | 0.126% | 0.888% | 0.540% |
| 12Z,15Z- | | | |
| octadecadienamide or | | | |
| isomer | | | |
| N-benzyl-9-oxo-12Z- | 0.031% | 0.262% | 0.176% |
| octadecenamide | | | |
| (9Z,12Z,15Z)-N- | 0.069% | 0.466% | 0.328% |
| (Phenylmethyl)- | | | |
| 9,12,15- | | | |
| octadecatrienamide | | | |
| N-(3-methoxybenzyl)- | <0.01% | 0.141% | 0.102% |
| (9Z,12Z,15Z)- | | | |
| octadecatrienamide | | | |
| (9Z,12Z)-N- | 0.058% | 0.417% | 0.285% |
| (Phenylmethyl)-9,12- | | | |
| octadecadienamide | | | |
| (9Z,12Z)-N-[(3- | <0.01% | 0.046% | 0.033% |
| Methoxyphenyl)methyl]- | | | |
| 9,12-octadecadienamide | | | |
| N-(m-methoxybenzyl) | 0.012% | 0.160% | 0.107% |
| hexadecanamide | | | |
| Macamide 1(N- | 0.116% | 1.006% | 0.639% |
| benzylhexadecanamide) | | | |
| 9-Octadecenamide, N- | 0.039% | 0.277% | 0.185% |
| (phenylmethyl)-, (9Z)- | | | |
| (9Z)-N-[(3- | <0.01% | 0.019% | 0.012% |
| Methoxyphenyl)methyl]- | | | |
| 9-octadecenamide | | | |
| N-Benzyloctadecanamide | <0.01% | 0.083% | 0.051% |
| Total | 0.451% | 3.765% | 2.460% |

Masking properties of the ethanolic, ethyl acetate and isobutanol extracts of Examples 1, 2, and 3, respectively, were assessed by a trained taste panel. The results of this analysis (Table 4) indicated that the extracts enhanced the umami perception and masked the beany, earthy, and bitter flavors of the pea protein isolate.

TABLE 4

| | | Bitter/Astringent | |
|---|---|---|---|
| | | Component | Aroma Component |
| Sample | | Perception | Perception |
| 1 | 1.5% Pea protein | Tastes like soap, | Beany |
| | isolate | bitter, soapy, dry, | |
| | | astringent | |
| 2 | 95% ethanol | Less bitter front, | Less beany, cleaner |
| | extract (Example | less soapy | bean note, more |
| | 1) at 25 ppm in | character, less dry | rounded, lighter, |
| | sample 1 | and astringent | less earthy, less |
| | | | drying |
| 3 | Ethyl acetate | Clean, no bitter in | Very nice, cleaner, |
| | extract (Example | front, no | less earthy, does |
| | 2) at 3 ppm in | soapiness, slightly | not sit on profile |
| | sample 1 | umami, almost like | but cleans up off |
| | | MSG | notes, less earthy, |
| | | | pasty, and powdery |
| 4 | Isobutanol | Clean and bright up | Cleaner, less |
| | extract (Example | front, no | earthy, does not sit |
| | 3) at 4.5 ppm in | bitterness, very | on profile but |
| | sample 1 | clean, no | cleans up off notes, |
| | | astringency, very | less earthy, pasty, |
| | | slight | and powdery |
| | | mouthfeel/umami | |

### Example 5: Analysis of L. meyenii Extracts with Varying Amounts of Macamides

Four different batches of ethanolic extracts of L. meyenii were prepared (Table 5) and assessed by a trained taste panel for taste modulating activity either as is or diluted at a 1:4 ratio of extract:glycerine. The results of this analysis (Table 6) indicated that the extracts masked the bitter, sour, fishy, earthy, gritty, chalky, burnt, beany, metallic and astringent flavors of a 5% pea protein isolate solution.

TABLE 5

| | | Total | Tasting |
|---|---|---|---|
| Sample | | Macamides | Level |
| 5 | Unflavored 5% Pea | — | — |
| | protein isolate | — | — |
| 6 | Control (57 μl Ethanol) | | |
| 7 | Extract Batch 1 | 0.30% | 25 ppm |
| | (Ethanolic Extract) | | |
| 8 | Extract Batch 1 (1:4 | 0.07% | 107 ppm |
| | glycerine dilution) | | |
| 9 | Extract Batch 2 | 0.07% | 107 ppm |
| | (1:4 glycerine | | |
| | dilution) | | |
| 10 | Extract Batch 3 (1:4 | 0.10% | 75 ppm |
| | glycerine dilution) | | |
| 11 | Extract Batch 4 | 0.22% | 34 ppm |
| | (Ethanolic Extract) | | |
| 12 | Extract Batch 4 | 0.22% | 68 ppm |
| | (1:4 glycerine | | |
| | dilution) | | |

TABLE 6

| | Sample | | | | | | | |
|---|---|---|---|---|---|---|---|---|
| Off Taste | 5 | 6 | 7 | 8 | 9 | 10 | 11 | 12 |
| Bitter | 8 | 8 | 2 | 2 | 3 | 3 | 4 | 3.5 |
| Sour | 6 | 6 | 3 | 3 | 2 | 3 | 3 | 3 |
| Fishy | 2 | 2 | 0 | 0 | 0 | 0 | 0 | 0 |
| Earthy | 7 | 7 | 4 | 3 | 3 | 3 | 3 | 2 |
| Gritty | 7 | 7 | 4 | 3 | 3 | 3 | 2 | 3 |
| Chalky | 8 | 8 | 4 | 4 | 3 | 4 | 2 | 4 |
| Burnt | 0 | 0 | 0 | 0 | 0 | 0 | 0 | 0 |
| Beany | 8 | 8 | 4 | 3 | 2 | 2 | 4 | 4 |
| Nutty | 2 | 2 | 4 | 3 | 3 | 2 | 1 | 1 |
| Astringent | 8 | 8 | 4 | 3 | 2 | 2 | 2 | 2 |
| Metallic/ | 4 | 4 | 2 | 2 | 2 | 2 | 1 | 2 |
| Unpleasant | | | | | | | | |
| Liking | 10 | 10 | 2 | 2 | 2 | 2 | 3 | 2 |
| Score | | | | | | | | |

Numbers indicate intensity. Liking Score, 1 is best, 10 is worst.

### Example 6: Fractionation and Analysis of L. meyenii Extracts

To ascertain the taste active compounds from the ethanolic extract of L. meyenii, sensory guided fractionation was performed using a semi-prep HPLC instrument. More than 22 fractions were collected based on the polarity of the compounds and each was individually tested for taste masking properties. Of these, ten isolated fractions exhibited bitter, off-taste masking properties. The taste active fractions were further purified using semi-prep HPLC and simultaneously identified through MS/NMR analysis as N-benzyloleamide (CAS No: 101762-87-2); N-benzyl linoleamide (CAS No: 18286-71-0); N-benzyllinolenamide (CAS No: 883715-18-2); Macamide 2 (CAS No: 405906-95-8); Macamide 1 (CAS No. 74058-71-2); N-(3-methoxybenzyl) oleamide (CAS No: 883715-21-7); N-benzyloctadecanamide (CAS No: 5327-45-7), and (9Z,12Z)-N-[(3-methoxyphenyl)methyl]-9,12-octadecadienamide (CAS No: 883715-22-8).

Sensory analysis of the aromatic alkamides was carried out. Specifically, each isolated fraction, corresponding to each of the aromatic alkamides in Table 7 (samples 14 to 21) (0.5 ppm), was added to a 4% pea protein isolate solution and the ability of the fraction to mask protein off-taste, bitterness, and/or astringency was assessed by a trained taste panel. The results of this analysis (Table 7) indicated that certain fractions enhanced umami perception and masked the beany, earthy, and bitter flavors of the pea protein isolate.

TABLE 7

| | | Sensory taste in 4% protein |
|---|---|---|
| Sample | | base |
| 13 | 95% Ethanol extract of | Masks protein off-taste, |
| | L. meyenii (Example 1) | bitterness, and astringency, |
| | at 25 ppm | cleaner front, more |
| | | mouthfeel. Best masking |
| | | solution. |
| 14 | N-Benzyloleamide | Little masking. |
| 15 | N-Benzyl linoleamide | Little masking. |
| 16 | N-Benzyl linolenamide | Moderate masking. |
| 17 | Macamide 2 | Good masking. |
| 18 | Macamide 1 | Good masking. Better than |
| | | Samples 17, 16, 15, or 14. |
| 19 | N-(3-methoxybenzyl) | Moderate masking. Same as |
| | oleamide | Sample 17. |
| 20 | N-Benzyloctadecanamide | Significant masking. Best |
| | | among all samples. Also |
| | | showed some umami |
| | | enhancement. |
| 21 | (9Z,12Z)-N-[(3- | Second best. Comparable to |
| | Methoxyphenyl)methyl]- | Sample 18. |
| | 9,12-octadecadienamide | |

The activities of the aromatic alkamides were further tested in different applications and at different levels. In particular, sensory tastes of pure compounds were tested in a lemon-flavored vitamin water zero mock base (Table 8) at 0.1 ppm and 0.5 ppm and in 20% cranberry juice at 0.5 ppm and compared to the taste profile of a 95% ethanolic extract of L. meyenii root (Example 1). Cranberry juice (100%) was purchased from Knudsen & Son, Inc. (Chico, Calif.) and diluted in water (1:5 ratio, w/w) for analysis. The results of these analyses are presented in Table 9.

TABLE 8

| Vitamin Water Ingredient | % | quantity (g) |
|---|---|---|
| Stevia - 97% RebA | 0.04 | 0.4 |
| Sodium Citrate | 0.02 | 0.2 |
| Sodium Chloride | 0.025 | 0.25 |
| Citric Acid | 0.1 | 1 |
| Ascorbic Acid | 0.22 | 2.2 |
| Phosphoric Acid 85% | 0.015 | 0.15 |
| Vitamin Premix | 0.04 | 0.4 |
| Water | Q.S to 100 ml | Q.S to 1000 ml |

TABLE 9

| | | | | Cranberry |
|---|---|---|---|---|
| Sample | | Vitamin Water | | Juice |
| 22 | 95% Ethanol | At 25 ppm - | At 25 ppm - | At 0.5 ppm - |
| | extract of L. | Cleaner | Nicer sweet | Less sour |
| | meyenii (Example | front, more | profile, not | front, still |
| | 1) at 25 ppm | mouthfeel, | as bitter, | dry, less |
| | | only sits on | not as | bitter |
| | | lemon | astringent | |
| | | slightly | | |
| | | less linger | | |
| 23 | N-Benzyloleamide | At 0.1 ppm - | At 0.5 ppm - | At 0.5 ppm - |
| | | Drinkable, | Less sour, | Bitter, |
| | | and does not | less bitter | astringent, |
| | | sit on | | less front |
| | | flavor | | sour |
| 24 | N-Benzyl | At 0.1 ppm - | At 0.5 ppm - | At 0.5 ppm |
| | linoleamide | Does not sit | Less sour, | Makes |
| | | on acid, | less bitter | fruitier, |
| | | still some | | covers |
| | | linger but | | bitter and |
| | | covers | | astringency |
| | | vitamin | | |
| | | quite a bit | | |
| 25 | N-Benzyl | At 0.1 ppm - | At 0.5 ppm - | At 0.5 ppm - |
| | linolenamide | Still sour, | More fruity, | Greener, |
| | | does not sit | pushes lemon | less bitter |
| | | on flavor, | profile, | less drying |
| | | covers | more | |
| | | unpleasant | candied, | |
| | | sourness? | less bitter, | |
| | | Vitamin? | slight green | |
| | | | note | |
| 26 | Macamide 2 | At 0.1 ppm - | At 0.5ppm - | At 0.5 ppm - |
| | | Still sour, | Less bitter, | Less bitter, |
| | | less bitter | slightly | less |
| | | than control | nicer sweet | astringent, |
| | | | profile | works best |
| | | | | in this base |
| 27 | Macamide 1 | At 0.1 ppm - | At 0.5 ppm - | At 0.5 ppm - |
| | | Still sour, | Front flat, | Nothing |
| | | not as much | end worse | |
| | | difference | | |
| | | from control | | |
| 28 | N-(3- | At 0.1 ppm - | At 0.5 ppm - | At 0.5 ppm - |
| | methoxybenzyl) | Still sour, | Bitter, | Nothing |
| | oleamide | not as much | nasty | |
| | | difference | | |
| | | from control | | |
| 29 | N-Benzyl | At 0.1 ppm - | At 0.5 ppm - | At 0.5 ppm - |
| | octadecanamide | Still sour, | Not much | Nothing |
| | | not as much | difference | |
| | | difference | | |
| | | from control | | |
| 30 | (9Z,12Z)-N-[(3- | At 0.1 ppm - | At 0.5 ppm - | At 0.5 ppm - |
| | Methoxyphenyl) | Thinner, not | Weird flavor | Nothing |
| | methyl]-9,12- | that | profile, | |
| | octadecadienamide | positive of | more | |
| | | an effect | metallic | |

### Example 7: Modulation of Umami Perception

The ability of L. meyenii extracts and fractions thereof to modulate umami flavors was determined by adding 25 ppm of an ethanolic extract of L. meyenii root (Example 1), 2 ppm of an ethyl acetate layer of a crude ethanolic extract, or 0.5 ppm of a fraction enriched in N-benzyloctadecanamide to a 0.4% Chicken Bouillon solution (Knorr Chicken Bouillon). Sensory analyses of the above-referenced compositions were carried out by a trained panel, the results of which are presented in Table 10.

TABLE 10

| Sample | | Chicken Bouillon |
|---|---|---|
| 31 | Ethanolic extract of L. | Provided enhancement, full |
| | meyenii root | body |
| 32 | Ethyl acetate layer of a | Significant in overall |
| | crude ethanolic extract | mouth fullness perception |
| | | (delicious) |
| 33 | N-Benzyloctadecanamide | Showed some enhancement |

### Example 8: Individual and Blends of Aromatic Alkamides

Individual and combinations of aromatic alkamides were further tested for masking bitter, astringent and off-tastes of a protein sample. In particular, a blend of isolated aromatic alkamides identical to the ethanolic extract of L. meyenii root (Table 3) was prepared (Sample 35). The control protein sample was pea protein isolate (dissolved in water to make a 4% tasting solution) with 500 μl of ethanol added thereto. The results of the sensory analyses are presented in Table 11.

TABLE 11

| Sample | | Sensory perception |
|---|---|---|
| 34 | Control protein | Soapy, nutty, soapy bitter |
| | | end |
| 35 | Blend of isolated | Less soapy and less bitter, |
| | aromatic alkamides at | still nutty, end still |
| | 0.1 ppm | slightly astringent |
| 36 | N-Benzyloleamide at 0.1 | Cleaner front, less flavor, |
| | ppm | nice profile |
| 37 | N-Benzyl linoleamide at | More umami, some bitterness, |
| | 0.1 ppm | then drying, sucks all the |
| | | moisture out of the mouth |
| 38 | N-Benzyl linolenamide | Still soapy, still nutty, |
| | at 0.1 ppm | slight umami |
| 39 | Macamide 2 at 0.1 ppm | Nutty front, not as soapy |
| | | tasting, ok but not as good |
| | | as N-Benzyloleamide |
| | | or N-Benzyloctadecanamide |
| 40 | Macamide 1 at 0.1 ppm | Still nutty, still some |
| | | soapiness, very nutty end, |
| | | then chicken end, better for |
| | | savory applications |
| 41 | N-(3-methoxybenzyl) | Less nutty front, less soapy, |
| | oleamide at 0.1 ppm | less bitter |
| 42 | N-Benzyloctadecanamide | Nutty but then milky tasting, |
| | at 0.1 ppm | not soapy or bitter |
| 43 | (9Z,12Z)-N-[(3- | Fairly clean, some drying end |
| | Methoxyphenyl)methyl]- | but cleaner profile, mild |
| | 9,12-octadecadienamide | nuttiness, much less |
| | at 0.1 ppm | soapiness |
| 44 | 95% Ethanol extract of | No soapiness, no bitterness, |
| | L. meyenii (Example 1) | still nutty |
| | at 25 ppm | |

Additional compositions were prepared (Table 12) and assessed by a trained taste panel for taste modulating activity as compared to an ethanol extract of L. meyenii. The protein control sample was a 5% pea protein isolate solution with 200 μl of ethanol added thereto. The results of this analysis (Table 13) indicated that the individual aromatic alkamides and blend thereof masked the bitter, sour, earthy, gritty, chalky, beany, metallic and astringent flavors of the protein.

TABLE 12

| | | Total |
|---|---|---|
| Sample | | Macamides |
| 45 | Protein Control | — |
| 46 | 95% Ethanol extract of L. meyenii | 0.30% |
| | (Example 1) at 25 ppm | |
| 47 | 0.006775 ppm N-benzyloleamide + | 0.050794 |
| | 0.00009425 ppm N-Benzyloctadecanamide+ | ppm |
| | 0.033775 ppm Macamide 1 + | |
| | 0.01015 ppm Macamide 2 | |
| 48 | N-benzyloleamide | 0.006775 |
| | | ppm |
| 49 | N-Benzyloctadecanamide | 0.00009425 |
| | | ppm |
| 50 | Macamide 1 | 0.033775 |
| | | ppm |
| 51 | Macamide 2 | 0.01015 |
| | | ppm |

TABLE 13

| | Sample | | | | | | |
|---|---|---|---|---|---|---|---|
| Off Taste | 45 | 46 | 47 | 48 | 49 | 50 | 51 |
| Bitter | 7 | 4 | 4 | 2 | 2 | 2 | 3 |
| Sour | 5 | 3 | 3 | 2 | 2 | 2 | 3 |
| Fishy | 0 | 0 | 0 | 0 | 0 | 0 | 0 |
| Earthy | 5 | 2 | 2 | 2 | 2 | 2 | 2 |
| Gritty | 5 | 2 | 3 | 4 | 2 | 2 | 2 |
| Chalky | 6 | 2 | 2 | 6 | 2 | 2 | 2 |
| Burnt | 0 | 0 | 0 | 0 | 0 | 0 | 0 |
| Beany | 8 | 3 | 3 | 5 | 3 | 3 | 5 |
| Nutty | 2 | 2 | 2 | 2 | 2 | 0 | 2 |
| Astringent | 5 | 2 | 2 | 4 | 2 | 2 | 2 |
| Metallic/ | 5 | 1 | 1 | 2 | 2 | 1 | 1 |
| Unpleasant | | | | | | | |
| Liking | 10 | 3 | 3 | 2 | 1 | 1 | 2 |
| Score | | | | | | | |

Numbers indicate intensity. Liking Score, 1 is best, 10 is worst.

N-benzyloleamide was combined with the other individual aromatic alkamides (Table 14) to determine whether any synergies existed. The combinations were assessed by a trained taste panel for taste modulating activity as compared to an ethanol extract of L. meyenii. The protein control sample was a 5% pea protein isolate solution with 200 μl of ethanol added thereto. The results of this analysis presented in (Table 15) indicated that while the combination of N-benzyloleamide+N-Benzyloctadecanamide+Macamide 1 and Macabide 2 exhibited the best taste masking activity, synergies were also observed when N-benzyloleamide was combined with either Macamide 1 or Macamide 2.

TABLE 114

| Sample | Components |
|---|---|
| 52 | Protein Control |
| 53 | 95% Ethanol extract of L. meyenii |
| | (Example 1) at 25 ppm (30% macamides) |
| 54 | 0.006775 ppm N-benzyloleamide + |
| | 0.00009425 ppm N-Benzyloctadecanamide + |
| | 0.033775 ppm Macamide 1 + |
| | 0.01015 ppm Macamide 2 |
| 55 | 0.006775 ppm N-benzyloleamide + |
| | 0.00009425 ppm N-Benzyloctadecanamide |
| 56 | 0.006775 ppm N-benzyloleamide + |
| | 0.033775 ppm Macamide 1 |
| 57 | 0.006775 ppm N-benzyloleamide + |
| | 0.01015 ppm Macamide 2 |
| 58 | 0.006775 ppm N-benzyloleamide + |
| | 0.013 ppm N-benzyl linoleamide |
| 59 | 0.006775 ppm N-benzyloleamide + |
| | 0.0118 ppm N-benzyl linolenamide |
| 60 | 0.006775 ppm N-benzyloleamide + |
| | 0.00021 ppm N-(3-methoxybenzyl)oleamide |
| 61 | 0.006775 ppm N-benzyloleamide + |
| | 0.00016 ppm (9Z,12Z)-N-[(3-methoxyphenyl)methyl]- |
| | 9,12-octadecadienamide |

TABLE 15

| | Sample | | | | | | | | | |
|---|---|---|---|---|---|---|---|---|---|---|
| Off Taste | 52 | 53 | 54 | 55 | 56 | 57 | 58 | 59 | 60 | 61 |
| Bitter | 8 | 2 | 4 | 5 | 2 | 3 | 3.5 | 3 | 4 | 2 |
| Sour | 6 | 3 | 3 | 2 | 2 | 2 | 2 | 2 | 2 | 4 |
| Fishy | 2 | 0 | 0 | 0 | 0 | 0 | 0 | 0 | 0 | 0 |
| Earthy | 7 | 4 | 2 | 4 | 3 | 3 | 3 | 3 | 4 | 2 |
| Gritty | 7 | 4 | 3 | 2 | 2 | 2 | 2 | 2 | 4 | 2 |
| Chalky | 8 | 4 | 2 | 2 | 2 | 2 | 2 | 4 | 4 | 4 |
| Burnt | 0 | 0 | 0 | 0 | 0 | 0 | 0 | 0 | 0 | 0 |
| Beany | 8 | 4 | 3 | 4 | 3 | 3 | 4 | 4 | 5 | 4 |
| Nutty | 2 | 4 | 2 | 5 | 3 | 3 | 4 | 2 | 2 | 3 |
| Astringent | 8 | 4 | 2 | 4 | 2 | 2 | 4 | 3 | 3 | 2 |
| Metallic/ | 4 | 2 | 1 | * | 2 | 2 | 2 | 2 | 3 | 2 |
| Unpleasant | | | | | | | | | | |
| Liking | 10 | 2 | 3 | 5 | 2 | 2 | 4 | 3 | 4 | 4 |
| Score | | | | | | | | | | |

Numbers indicate intensity. Liking Score, 1 is best, 10 is worst.
*Very high umami flavor.

What is claimed is:

1. A consumable comprising a component having an astringent, bitter or off-taste; and one or a combination of aromatic alkamides selected from the group of N-benzyloleamide, N-benzyl linoleamide, N-benzyllinolenamide, macamide 2, macamide 1, N-(3-Methoxybenzyl) oleamide, N-benzyloctadecanamide or (9Z,12Z)-N-[(3-methoxyphenyl)methyl]-9,12-octadecadienamide.

2. The consumable of claim 1, wherein the component having an astringent, bitter or off-taste is a protein, carbohydrate sweetener, artificial sweetener or preservative.

3. The consumable of claim 1, wherein the aromatic alkamides are in the form of an aromatic alkamide-enriched Lepidium meyenii extract.

4. The consumable of claim 3, wherein the aromatic alkamide-enriched Lepidium meyenii extract is an ethanolic, ethyl acetate or isobutanol extract of L. meyenii root.

5. The consumable of claim 1, wherein the aromatic alkamides are at a concentration in the range of 1 part per trillion to 1000 parts per million in the consumable.

6. The consumable of claim 1, wherein the consumable is a food product, pharmaceutical composition, a dietary supplement, a nutraceutical, a dental hygienic composition, a tabletop sweetener, a beverage, or a cosmetic product.

7. A method of improving the taste of a consumable comprising adding to a consumable having a component with an astringent, bitter or off-taste, one or a combination of aromatic alkamides selected from the group of N-benzyloleamide, N-benzyl linoleamide, N-benzyllinolenamide, macamide 2, macamide 1, N-(3-Methoxybenzyl) oleamide, N-benzyloctadecanamide or (9Z,12Z)-N-[(3-methoxyphenyl)methyl]-9,12-octadecadienamide, in an amount effective to reduce or suppress said astringent, bitter or off-taste thereby improving the taste of a consumable.

8. The method of claim 7, wherein the component with an astringent, bitter or off-taste is a protein, carbohydrate sweetener, artificial sweetener or preservative.

9. The method of claim 7, wherein the aromatic alkamides are in the form of an aromatic alkamide-enriched Lepidium meyenii extract.

10. The method of claim 9, wherein the aromatic alkamide-enriched Lepidium meyenii extract is an ethanolic, ethyl acetate or isobutanol extract of L. meyenii root.

11. The method of claim 7, wherein the aromatic alkamides are at a concentration in the range of 1 part per trillion to 1000 parts per million in the consumable.

12. The method of claim 7, wherein the consumable is a food product, pharmaceutical composition, a dietary supplement, a nutraceutical, a dental hygienic composition, a tabletop sweetener, a beverage, or a cosmetic product.
